(19) United States
(12) Patent Application Publication
(10) Pub. No.: US 2005/0197083 A1
(43) Pub. Date: Sep. 8, 2005

(54) System and method for the adaptation of received digital data

(76) Inventor: Steven Jenkins, Saltaire (GB)

Correspondence Address: HEAD, JOHNSON & KACHIGIAN, 228 W 17TH PLACE, TULSA, OK, 74119, US

(21) Appl. No.: 11/070,807

(22) Filed: Mar. 2, 2005

(30) Foreign Application Priority Data
Mar. 3, 2004 (GB) 0404728.8

(51) Int. Cl. H04B 1/18

(52) U.S. Cl. 455/186.1; 455/161.2

(57) ABSTRACT

The invention relates to a system, apparatus and method to allow radio apparatus which can receive and process data in an analogue format such as FM and/or RDS, to continue to be used for the generation of audio and or a display when the original data which is received is in a digital format, such as in a DAB format, for a series of radio stations and/or when received from an electronic device. The invention provides an adaptor which is capable of receiving the data in the digital format and then processing the same and generating data, typically a portion of the received digital data, in an analogue format and transmitting the same to the radio apparatus for the generation of audio and/or a display via the same.

The invention to which this application relates is to the ability to adapt received digital data such as that received via Digital Audio Broadcasting (DAB), in a manner which is inventive and of benefit to the control and utilisation of a range of electronic data devices and particularly, although not exclusively, to allow the enhanced use of said devices in a vehicle environment.

It should be appreciated that although the invention is now described with respect to the use of the system in a vehicle, the system need not necessarily be restricted to such use and as a result the application should not be interpreted as being limited to use in a vehicle.

Until relatively recently, all radio apparatus provided in vehicles has received data carried in an analogue manner at specified frequencies within a given FM frequency range using analogue radio signals. However analogue radio signals are subject to numerous kinds of interference on their way from the transmitter to the radio, such problems being caused by geographical obstructions, high-rise buildings and/or weather conditions. A known feature which is provided with the signals is known as RDS (Radio Data System). RDS enables text data relating to the particular radio programme which is tuned to be displayed via the visual display of the radio apparatus, provided, for example, on the dashboard of the vehicle. This associated technology also allows the radio to be retuned within milliseconds as the frequency on which the data for a particular radio station is carried can change as the car in which the apparatus is provided, moves. During this process the audio signal is muted which, because of the short time taken to retune, is usually not detected by the ear. Thus, the radio apparatus is able to choose the transmitter frequency, among a number of alternatives, that gives the best quality reception for a given radio station. It is also ensured that the retuning is made to exactly the same programme service by performing an identity check using a programme identity (PI) code.

A more recent development has been to transmit data relating to radio stations by using Digital Audio Broadcasting (DAB). DAB creates digital data multipath reception conditions to optimise receiver sensitivity and always selects the strongest regional transmitter automatically. This therefore ensures that the data reception is greatly improved. The data is received in a vehicle using a suitable antenna without interference or signal distortion. In addition to the improved signal quality, DAB can carry text, pictures and data which can be generated on suitable display apparatus. This additional data can typically be displayed on the display of a DAB radio provided in the vehicle.

While this system is of undoubted advantage, a problem which is experienced by persons who wish to receive this service is that they either have to have bought a vehicle fitted with a DAB radio, which is currently unlikely, or have to consider a number of currently available alternatives when their vehicle is not fitted with the appropriate apparatus i.e. the car is provided with analogue data radio apparatus. One option is to remove the existing apparatus and replace it with a new DAB radio system. However the new apparatus is expensive and has to be fitted as a non original component. This can lead to the new apparatus not fitting properly in the dashboard, can lead to annoying rattles and is generally unsatisfactory.

Another solution is to purchase an additional piece of apparatus which is required to be fitted in location in the vehicle and attached to the analogue radio apparatus. However this can be expensive and may not always be compatible with the existing apparatus. A yet further possibility is that a personal DAB receiver can be used and provided with a cassette converter which is inserted in the cassette drive of the existing radio apparatus. However many vehicles do not have a cassette player and the personal apparatus is still required to be positioned somewhere in the vehicle.

For these reasons the retrofitting of DAB receiving apparatus has not been widescale, despite the obvious advantages of the DAB system.

The aim of the present invention is to provide a system whereby the provision of DAB reception can be achieved while utilising the existing analogue radio signal receiving apparatus. A further aim is for the system to allow further electronic digital data apparatus to be able to be used in conjunction with the additional apparatus to the advantage of the user.

In a first aspect of the invention there is provided a system for receiving and processing data for the generation of audio and/or a visual display selectable by a user via said system, said system including radio apparatus with a visual display for text and/or images, receiver means for receiving and processing data in analogue formats and characterised in that the system further includes an adaptor, said adaptor capable of processing data which is received in a digital format and generates from this received data, data in a format capable of reception and processing by the said radio apparatus for the generation of audio and/or a text display via the same.

In one embodiment the formats transmitted by the adaptor to the radio apparatus are FM format and/or RDS format for the generation of radio station outputs.

In one embodiment the received digital data is DAB data which includes digital audio data which is processed by the adaptor and then transmitted onwards to the radio apparatus for the generation of an FM radio station represented by said data.

Typically the adaptor demodulates the received digital data and transmits the same in an FM format.

Typically the received DAB data includes data for the provision of text, and said data is processed by the adaptor into an RDS format for transmission and display on the display screen. In one embodiment the display reflects the identity of the radio station selected at that instant by the user.

Typically, not all of the received data is processed and preferably the particular data of the received data which is processed is selected in response to a user selection at that time of a particular function of the radio apparatus, such as a particular radio station. A signal representative of the user selection is transmitted to the adaptor which, in turn, selects the appropriate digital data for the user selection and then processes the same into the required format to allow the appropriate radio station audio and text to be generated, typically via the radio apparatus.

In one embodiment the user selection is generated to the radio apparatus and/or the adaptor by the user utilising a remote control device which transmits an appropriate signal. Typically the remote control device can be provided in any suitable format to allow ease of use for the user, such as for example, if the system is provided in a vehicle, the remote control device can be mounted on the dashboard, on the steering wheel or at a suitable location.

Preferably the remote control device and as many of the other data connections as possible in the system are wireless thereby improving the ease of fitment of the components.

In one embodiment the adaptor receives a connector which connects a data receiving antenna to the adaptor. The transmission of the FM and RDS data from the adaptor device to the antenna can be by a cable connection plugged into the antenna port of the same or by the transmission of the data from the adaptor at a suitable frequency to be received by an FM antenna and passed to the radio apparatus.

In one embodiment the radio apparatus is that which is already fitted as part of the vehicle, thereby avoiding the need for the same to be removed or adapted in any way.

In a further format of the invention, instead of, or in addition to, the reception of digital data relating to radio stations, the digital data can be received from another electronic device such as a mobile telephone, PDA, traffic system, navigation system, MP 3 player and the audio data is processed by the adaptor and transmitted for generation of audio and the text data is processed and generated in an RDS format for display.

In one embodiment selection means are provided, perhaps on the remote control device, to allow the user to select which of a number of connected digital devices are used to provide the digital data to the adaptor at any given time.

In a further aspect of the invention there is provided an adaptor device for use with a system and method as herein described.

In a further aspect of the invention there is provided a method for the generation of a display and/or audio via radio apparatus provided for the receipt of FM and RDS format analogue signals, characterised in that said method includes the steps of receiving digital data via an adaptor from a digital data source, identifying and processing data relating to audio into an FM format, identifying and processing data relating to text into an RDS format, and transmitting the FMI and/or RDS format data to the radio apparatus for generation of audio and/or a display thereon.

In one embodiment only a selected portion of the received digital data is processed into an analogue format, said portion selected in response to a signal received which is indicative of a selection made by the user of the radio apparatus.

In one embodiment, if the digital data reception is interrupted, an equivalent analogue data signal to that which is being provided from the adaptor via the digital data, if it exists, is substituted and used by the radio apparatus for the generation of the audio and/or display. Typically, if the required digital data becomes available once more then use of the same is recommenced.

In a further aspect of the invention there is provided apparatus for the reception of DAB data, said apparatus including an adaptor capable of receiving and processing DAB data into one or a number of analogue formats, an antenna to which the analogue format data is transmitted by the adaptor and further apparatus capable of processing the said received analogue format data and generating audio and/or a display therefrom.

In one embodiment the adaptor processes a selected portion of the received DAB data and transmits the analogue format data representative of the selected portion only at any given time.

Typically the selected portion of the received DAB data is selected in response to a user generated signal.

In one embodiment the adaptor, antenna and further apparatus are provided within or adjacent to the same environment. In one embodiment the environment is a vehicle and the adaptor and further apparatus, typically in the form of a radio, are provided within the vehicle cabin and the antenna is provided attached externally of the vehicle or provided as an integral part thereof.

Specific embodiments of the invention are now described with reference to the accompanying drawings; wherein

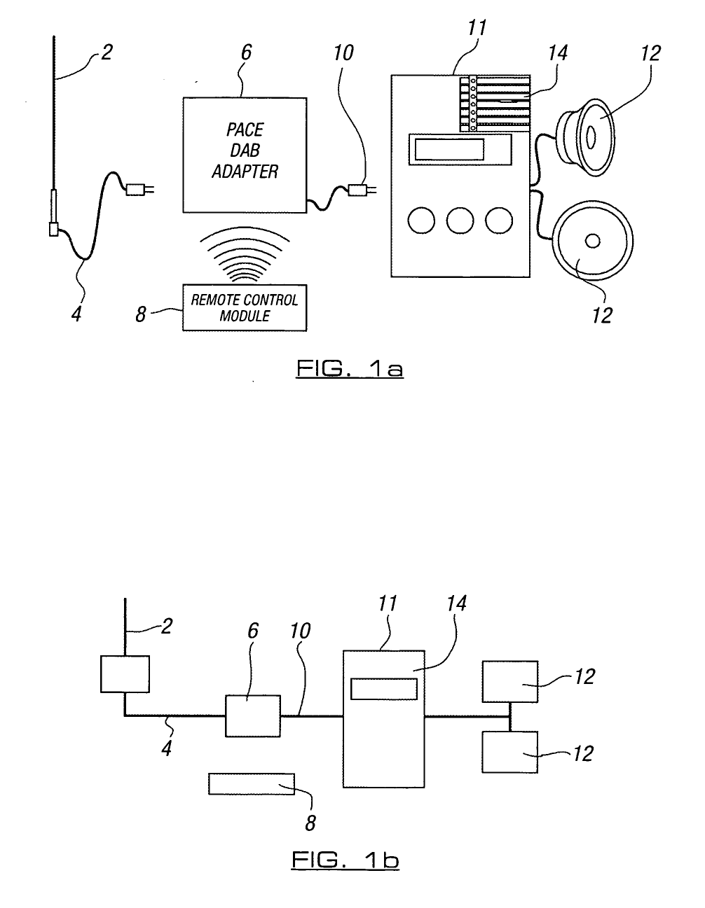

FIGS. 1a and b illustrates graphically and diagrammatically system components in accordance with one embodiment of the invention; and

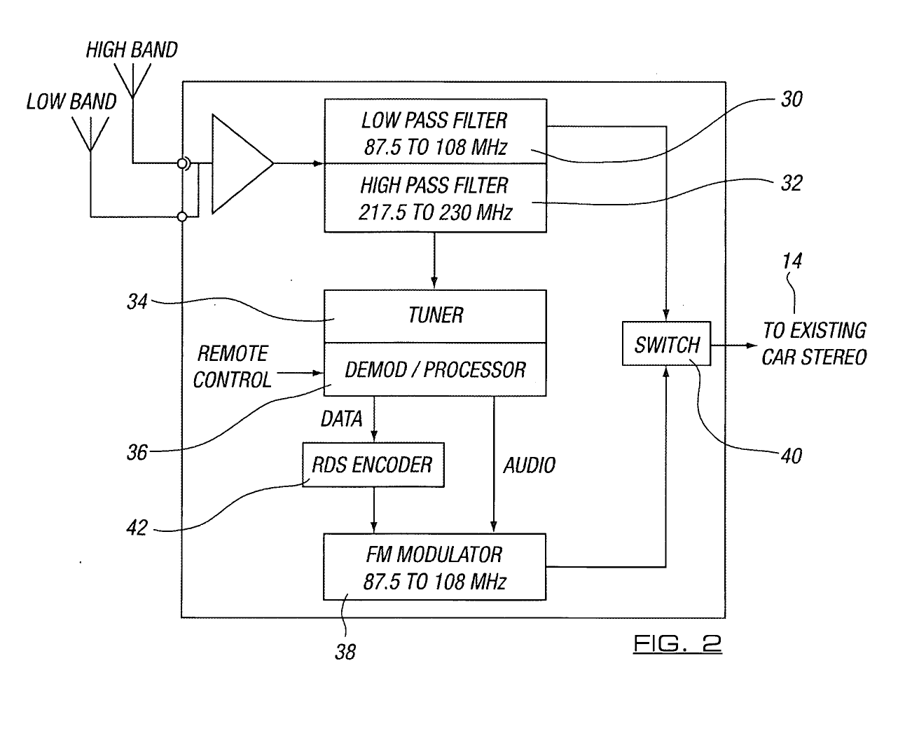

FIG. 2 illustrates in detail the adaptor in accordance with one embodiment of the invention.

Referring firstly to FIGS. 1a and b there is illustrated one embodiment of a system in accordance with the invention. The system includes a receiver antenna 2 for the reception of data in a digital DAB format or can use an existing antenna fitted to the vehicle. The antenna is provided with a connection means 4 with a plug leading to an adaptor which will be described in more detail with respect to FIG. 2. However, the adaptor 6 is capable of receiving control signals from a remote control device 8, which can be of any suitable, user friendly, format. The adaptor is in turn connected via cable 10 to radio apparatus 11 including means for generating audio, via speakers 12, and a display 14. As is shown, the audio and display means can be the “radio” apparatus already fitted into a vehicle and which is already capable of receiving FM radio and RDS signals.

In operation, the antenna 2 receives DAB data which is typically broadcast from one of a number of remote locations. The data which is received is passed to the adaptor via cable 4 and is selectively demodulated by the adaptor in response to a user selection via the remote control. For example, if the user wishes to listen to Radio 1, the adaptor identifies the appropriate portion of audio and text data from the digital data which is received. Having identified the required data, the adaptor adapts the same as is explained with regard to FIG. 2.

If at any stage the DAB signal is lost, the adaptor will transmit an RDS signal that will retune the radio apparatus to the equivalent FM station to that which has been selected by the user via the adaptor. This therefore ensures, as far as possible, that the user can always be able to listen to the required radio station.

In FIG. 2 there is shown one embodiment of the components of the adaptor. The adaptor includes a low pass filter 30 which provides the signal to the existing FM radio when required and a high pass filter 32 for the received data. In an adaptive format the received digital data is passed to the tuner 34 and demodulator/processor 36. The processor 36 receives the signal from the remote control device and therefore can refer to memory data, such as a digital data look up table to know what data is required to be dealt with in order for the user selection to be achieved. The appropriate digital data for audio is passed to the FM modulator 38 and adapted for transmission in an analogue format, when the switch 40 is appropriately set, to the radio apparatus in the suitable FM format which can be processed by the radio apparatus. The appropriate digital data for text or other display, if required, is sent to the RDS encoder 42 and placed into an RDS format prior to the FM modulator 38 where again the adapted data is transmitted to the radio apparatus 14.

Thus it will be readily seen that the appropriate data is adapted by the adaptor into an FM and RDS format thereby allowing the same to be transmitted to and received and processed by the existing radio apparatus. This avoids the need for the existing radio apparatus to be replaced as the radio apparatus receives the data signals in a conventional analogue format even though the same have originally been provided in a digital format. This therefore avoids the expense and inconvenience which this can cause.

Although illustrated with a cable connection between the adaptor and radio apparatus, it should be appreciated that the adaptor can include a transmitter which allows the adapted FM and RDS signals to be transmitted from the adapter for reception by an FM antenna fitted at the same location i.e. on the vehicle, with this system being usable where legally allowed. The FM antenna then receives this adapted data signal and passes the same to the radio apparatus.

In a further feature of the invention, the adaptor can allow the reception and operation of the apparatus in a conventional FM manner via the control of the switch 40. This can be as a result of the user selection to stop operation or as a result of the detection of the DAB data transmission. The switch can also be utilised to provide an interruption to allow a phone call to be answered for example.

In one embodiment the antenna 2 is provided in addition to the existing FM antenna and is provided so as to allow the reception of DAB data over the available range such as for example the high and/or low band ranges.

In addition or alternatively the received digital data which is processed need not be that which is transmitted as part of a DAB system and instead can be provided via another electronic device instead of the antenna 2. The said further device can be an MP3 player, GPS navigation system or the like, with audio and display data processed in the same manner as described above and with the same advantages being achieved. In this format the apparatus further includes a user selection means, which may be provided as part of the remote control device, which allows the user to select the source of the digital data which is to be selectively processed by the adaptor.

Thus the invention also allows the management of usage of a plurality of devices and is of particular advantage for the management of said devices in a confined environment such as a vehicle.

1. A system for receiving and processing data for the generation of audio and/or a visual display selectable by a user via said system, said system comprising:
radio apparatus with a visual display for text and/or images;
receiver means for receiving and processing data in analogue formats; and
an adaptor capable of processing data which is received in a digital format and generating from this received data, data in a format capable of receiving and processing by said radio apparatus for generation of audio and/or a text display via the same.

2. A system according to claim 1 wherein the formats transmitted by said adaptor to said radio apparatus are frequency modulation format and/or radio data system.

3. A system according to claim 1 wherein said received digital data format is digital audio broadcasting data which includes digital audio data which is processed by said adaptor and then transmitted to said radio apparatus for generation of a radio station represented by said data.

4. A system according to claim 3 wherein said adaptor demodulates the received digital data and transmits the same in an frequency modulation format.

5. A system according to claim 1 wherein said received digital data includes data for the provision of text, and said digital data is processed by said adaptor into an radio data system format for transmission and display on the visual display of said radio apparatus.

6. A system according to claim 5 wherein said display on said radio apparatus identifies of the radio station selected at that instant by the user.

7. A system according to claim 1 wherein said received digital data is selectively processed by said adaptor.

8. A system according to claim 7 wherein said selected data of the received data which is processed is selected in response to a user selection at that time of a particular function of said radio apparatus.

9. A system according to claim 8 wherein the selected particular function is a radio station.

10. A system according to claim 8 wherein a signal representative of the user selection is transmitted to said adaptor which, in turn, identifies and selects to process the digital data relevant to the user selection and then processes the same into a required analogue format to allow an appropriate audio and/or text to be generated.

11. A system according to claim 10 wherein the user selection is generated to said radio apparatus and/or said adaptor by the user utilizing a remote control device which transmits an appropriate signal.

12. A system according to claim 1 further including a data receiving antenna for receiving said digital data to said adaptor.

13. A system according to claim 1 wherein transmission of said data in analogue format from said adaptor to said radio apparatus is via a cable connection or at a suitable frequency to be received by an antenna and passed onto said radio apparatus.

14. A system according to claim 1 wherein said radio apparatus is fitted as part of a vehicle.

15. A system according to claim 1 wherein said data in digital format is received from electronic devices selected from the group consisting of: a mobile telephone, personal digital assistant, traffic information system, navigation system, and MP 3 players, and received audio data is processed by said adaptor and transmitted for generation of audio and the text data is processed and generated in an radio data system format for display via said radio apparatus.

16. A system according to claim 15 wherein selection means are provided to allow the user to select which of a number of connected digital devices are used to provide the digital data to the adaptor.

17. An apparatus for reception of digital audio broadcasting data, said apparatus comprising:
an adaptor capable of receiving and processing digital audio broadcasting data into at least one analogue formats,
an antenna to which the at least one analogue format data is transmitted by the adaptor; and
a further apparatus capable of processing said at least one analogue format data and generating audio and/or a display therefrom.

18. An apparatus according to claim 17 wherein said adaptor processes a selected portion of the received digital audio broadcasting data and transmits an analogue format data representative of the selected portion.

19. An apparatus according to claim 18 wherein said selected portion of the received digital audio broadcasting data is selected in response to a user generated signal.

20. An apparatus according to claim 17 wherein said adaptor, said antenna and said further apparatus are provided within or adjacent to a same environment.

21. An apparatus according to claim 20 wherein said same environment is a vehicle having a cabin and said adaptor and said further apparatus, typically in the form of a radio, are provided within the vehicle cabin and said antenna is provided attached externally of the vehicle or provided as an integral part thereof.

22. A method for generation of a display and/or audio via a radio apparatus provided for the receipt of frequency modulation and radio digital system format analogue signals, said method includes comprises the steps of
receiving digital data via an adaptor from a digital data source;
identifying and processing data relating to audio into a frequency modulation format;
identifying and processing data relating to text into a radio digital system format;; and
transmitting the frequency modulation and/or radio digital system format data to the radio apparatus for generation of audio and/or a display thereon.

23. A method according to claim 22 wherein only a selected portion of the received digital data is processed into an analogue format, said portion selected in response to a signal received which is indicative of a selection made by a user of the radio apparatus.

24. A method according to claim 22 wherein if the digital data reception is interrupted, an equivalent analogue data signal to that which is being provided from the adaptor via the digital data, if it exists, is substituted and used by the radio apparatus for the generation of the audio and/or display.

25. A method according to claim 24 wherein if the required digital data becomes available once more then use of the same is recommenced.

26. (canceled)
